(19) United States
(12) Patent Application Publication
(10) Pub. No.: US 2026/0172523 A1
(43) Pub. Date: Jun. 18, 2026

(54) IMAGE READING DEVICE, STORAGE MEDIUM, AND IMAGE FORMING SYSTEM

(71) Applicant: Konica Minolta, Inc., Tokyo (JP)

(72) Inventors: Motoki TAKATA, Toyohashi-shi (JP); Shogo ASAOKA, Toyokawa-shi (JP)

(21) Appl. No.: 19/417,847

(22) Filed: Dec. 12, 2025

(30) Foreign Application Priority Data
Dec. 13, 2024 (JP) 2024-218885

(51) Int. Cl. H04N 1/387; H04N 1/00

(52) U.S. Cl. CPC H04N 1/3878; H04N 1/00045; H04N 1/0066; H04N 1/00824; H04N 2201/0005

(57) ABSTRACT

An image reading device includes a reading conveyor; a reading scanner configured to read an image of a sheet conveyed by the reading conveyor during conveyance; and a hardware processor. The hardware processor performs control such that, from an adjustment chart in which one mark or a plurality of marks are formed, the one mark or the plurality of marks are read at two or more locations in a reading line. The hardware processor calculates an inclination in the main scanning direction from a difference in a mark width in one read line that has been read. The hardware processor calculates the inclination in the sub-scanning direction from the difference in a position or a width of the mark in the two reading lines which are read with the interval in the sub-scanning direction.

### CROSS-REFERENCE TO RELATED APPLICATION

The present invention claims priority under 35 U.S.C. § 119 to Japanese Patent Application No. 2024-218885, filed on Dec. 13, 2024, the entire contents of which being incorporated herein by reference.

### BACKGROUND OF THE INVENTION

### Technical Field

The present disclosure relates to an image reading device, a storage medium, and an image forming system.

### Description of Related Art

Generally, in an image reading device, inclination or distortion may occur in a read image due to various causes. Therefore, a method using an adjustment chart is conventionally known as a method for measuring and adjusting an inclination of a read image. For example, Japanese Unexamined Patent Publication No. 2017-092782 discloses a method of using an adjustment chart in which a plurality of marks in a square shape are arranged so that sides of the squares are parallel or perpendicular to vertical and horizontal sides of a sheet.

With the method disclosed in the above-described Japanese Unexamined Patent Publication No. 2017-092782, it is possible to measure an inclination amount due to flatness deviation and frame distortion of a scanning rail in the image reading device, and the like. However, the above-described method cannot measure an angular deviation amount between a document conveyance direction of the document conveyance device and a main scanning direction of the image reading device. Therefore, in some cases, the inclination of the read image cannot be adjusted by the conventional method.

### SUMMARY OF THE INVENTION

An object of the present disclosure, which has been made in view of the above-described problem, is to provide an image reading device, a storage medium, and an image forming system that can more reliably adjust an inclination of a read image.

To achieve the above object, according to one aspect of the present disclosure, an image reading device reflecting one aspect of the present disclosure includes:
a reading conveyor;
a reading scanner configured to read an image of a sheet conveyed by the reading conveyor during conveyance; and
a hardware processor,
wherein,
the hardware processor performs control such that, from an adjustment chart in which one mark or a plurality of marks are formed, the one mark having a plurality of oblique sides whose widths change in a main scanning direction or a sub-scanning direction and which are symmetrically shaped with respect to a center line in the main scanning direction and the plurality of marks include the oblique side, the one mark or the plurality of marks are read at two or more locations in a reading line that is one or more pixels in the sub-scanning direction and that includes pixels corresponding to a width of the adjustment chart in the main scanning direction at intervals in the sub-scanning direction,
the hardware processor calculates an inclination in the main scanning direction from a difference in a mark width in one read line that has been read, and
the hardware processor calculates the inclination in the sub-scanning direction from the difference in a position or a width of the mark in the two reading lines which are read with the interval in the sub-scanning direction.

According to another aspect of the present disclosure, a storage medium according to one aspect of the present disclosure is a non-transitory computer-readable storage medium storing a program that causes a computer of an image reading device that reads an image of a sheet conveyed by a reading conveyor using a reading scanner during conveyance to,
perform control such that, from an adjustment chart in which one mark or a plurality of marks are formed, the mark having a plurality of oblique sides whose widths change in a main scanning direction or a sub-scanning direction and which are symmetrically shaped with respect to a center line in the main scanning direction, the one mark or the plurality of marks are read at two or more locations in a reading line that is one or more pixels in the sub-scanning direction and that includes pixels corresponding to a width of the adjustment chart in the main scanning direction at intervals in the sub-scanning direction,
calculate an inclination in the main scanning direction from a difference in a mark width in one read line that has been read, and
calculate the inclination in the sub-scanning direction from the difference in a position or a width of the mark in the two reading lines which are read with the interval in the sub-scanning direction.

According to another aspect of the present disclosure, an image forming system reflecting one aspect of the present disclosure includes,
the image reading device described above; and
an image former that forms an image on a sheet using image data obtained by the image reading device.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present disclosure, and wherein:

FIG. 1 is an overall side cross-sectional view of an image forming system;

FIG. 2 is a block diagram of the image forming system;

FIG. 3 is an example of an adjustment chart;

FIG. 4 is a diagram for explaining inclination calculation at the time of image reading using the adjustment chart;

FIG. 5 is a diagram illustrating a case where a document to be read is normally conveyed;

FIG. 6 is a diagram illustrating a case where a document to be read is conveyed in an inclined state;

FIG. 7 is a diagram illustrating an image read in an inclined state;

FIG. 8 is a perspective view illustrating a state in which a reading conveyance section of an image reading device of FIG. 1 is developed;

FIG. 9 is a diagram for explaining adjustment by an angle adjustment mechanism;

FIG. 10 is a diagram illustrating correction by a correction section;

FIG. 11 is a view illustrating an example of display by a display part;

FIG. 12 is a flowchart illustrating angle adjustment processing using an adjustment chart;

FIG. 13 is a flowchart illustrating correction processing by a correction section; and

FIG. 14 is a diagram illustrating a modification example of the adjustment chart.

### DETAILED DESCRIPTION

Hereinafter, one or more embodiments of the present disclosure will be described with reference to the drawings. However, the scope of the invention is not limited to the disclosed embodiments.

Hereinafter, an image forming system 1 according to an embodiment of the present disclosure is described below with reference to the drawings. However, the scope of the invention is not limited to the illustrated examples. In the following description, components having the same function and configurations are denoted by the same reference numerals, and the description thereof will be omitted.

### Image Forming System

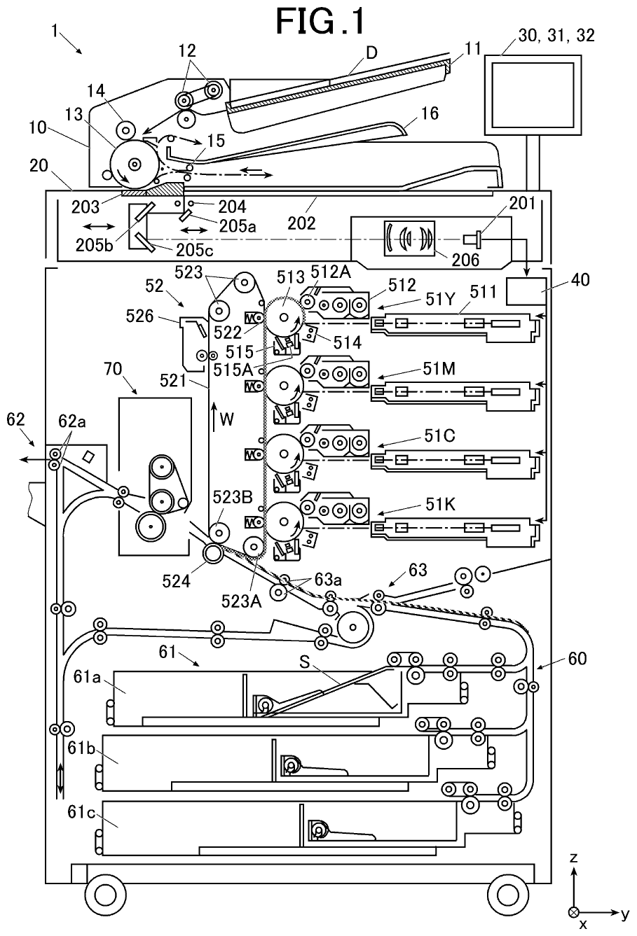

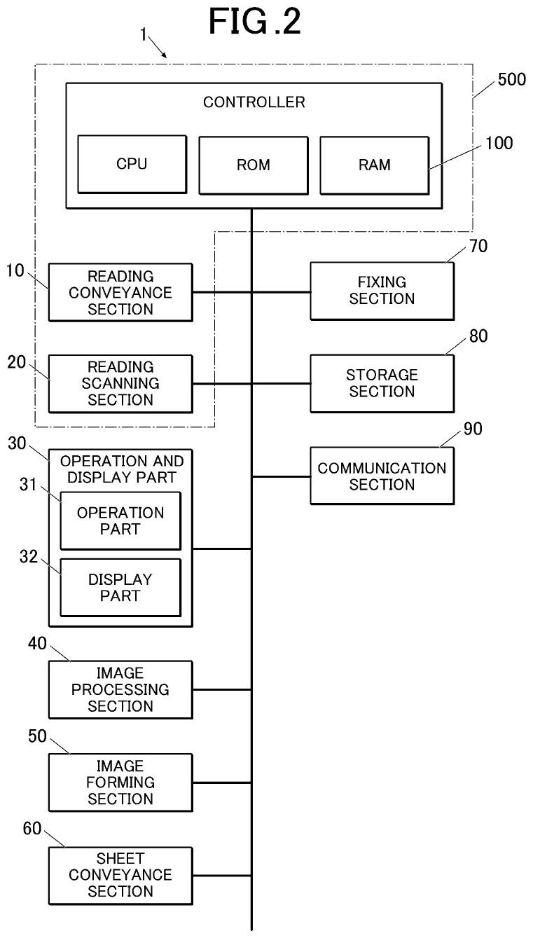

FIG. 1 is a schematic diagram illustrating an overall configuration of an image forming system 1. FIG. 2 is a block diagram illustrating a main functional configuration of the image forming system 1. The image forming system 1 includes a reading conveyance section 10 (reading conveyor), a reading scanning section 20 (reading scanner), an operation and display part 30, an image processing section 40, an image forming section 50 (image former), a sheet conveyance section 60, a fixing section 70, a storage section 80, a communication section 90, and a controller 100 (hardware processor).

The reading conveyance section 10, the reading scanning section 20, and the controller 100 constitute an image reading device 500.

Hereinafter, an X direction, a Y direction, and a Z direction refer to directions illustrated in FIG. 1.

### Reading Conveyance Section

The reading conveyance section 10 includes an automatic document feeder (ADF: Auto Document Feeder). The reading conveyance section 10 includes a sheet feed tray 11 and a sheet feed roller 12 that conveys a document D placed on the sheet feed tray 11. Furthermore, the reading conveyance section 10 includes a contact roller 13 with which the document D is made to pass in close contact with a platen glass 202 which is a reading position of the document, and a guide roller 14 which guides the document D conveyed by the sheet feed roller 12 along the contact roller 13. The reading conveyance section 10 conveys the document D placed in the sheet feed tray 11 to the reading position on the platen glass 202 on a sheet-by-sheet basis. The reading conveyance section 10 includes a conveyance roller 15 that conveys the document D for which reading has been completed, and a sheet ejection tray 16 to which the document D is discharged. The reading conveyance section 10 conveys the document D in a state in which a bottom surface is in contact with the platen glass 202 of the reading scanning section 20. Furthermore, the reading conveyance section 10 is rotatably connected to a housing of the image forming section 50 by a hinge part 19 (see FIG. 8).

The reading conveyance section 10 further includes an angle adjustment mechanism 17 to be described later.

### Reading Scanning Section

The reading scanning section 20 operates to read an image formed on the document D. As the reading scanning section 20, for example, a slit scanning type scanner for color scanning is used. The reading scanning section 20 includes an image sensor 201 arranged in an array. The reading by the reading scanning section 20 is performed such that, for example, when the document D is turned over in a U shape by the contact roller 13, the surface of the document D is read and an image reading signal is output. For the image sensor 201, for example, a three line color charge coupled device (CCD) imaging apparatus is used.

The image sensor 201 includes three reading sensors for detecting red (R) color light, green (G) color light, and blue (B) color light, which are configured by arranging a plurality of light receiving element rows in the main scanning direction. Due to the image sensor 201, the reading by the reading scanning section 20 is performed such that the pixels are divided at different positions in a sub-scanning direction orthogonal to the main scanning direction and optical information of the R color, the G color, and the B color is read at the same time.

The document D read by the reading scanning section 20 is conveyed by the conveyance roller 15 and ejected to the sheet ejection tray 16.

In addition to the image sensor 201, the reading scanning section 20 includes the platen glass 202, a contact glass 203 (ADF glass), a light source 204, a mirror 205a, a mirror 205b, a mirror 205c, an imaging optical unit 206, and an optical drive section (not particularly illustrated). The light source operates to irradiate the document D with light. The optical drive section operates to relatively move the document D or the image sensor 201 in the sub-scanning direction. The sub-scanning direction refers to a direction orthogonal to a main scanning direction when the main scanning direction is an arrangement direction of a plurality of light receiving elements forming the image sensor 201. In FIG. 1, the X direction is a main scanning direction and the Y direction is the sub-scanning direction. As described above, the document D placed on the sheet feed tray 11 of the reading conveyance section 10 is conveyed by the sheet feed roller 12, the contact roller 13, the guide roller 14, and the conveyance roller 15 described above. Next, an image on one side of the document D is scanned and exposed by the optical system of the reading scanning section 20, and incident light reflecting the image reading is read by the image sensor 201. The image sensor 201 photoelectrically converts the read incident light according to the light amount. The photoelectrically converted analog image reading signal becomes digital document image data via the controller 100.

The reading scanning section 20 outputs the document image data obtained in the above process to the controller 100.

### Operation and Display Part

The operation and display part 30 includes, for example, a liquid crystal display (LCD) with a touch screen. The operation and display part 30 functions as an operation part 31 and a display part 32 (display).

### Operation Part

The operation part 31 includes various operation keys such as a numeric keypad and a start key. The operation part 31 accepts various kinds of input operation by the user and outputs an operation signal to the controller 100.

### Display Part

The display part 32 displays various operation screens, a state of an image, an operating status of each function, or the like according to a display control signal input from the controller 100.

### Image Processing Section

The image processing section 40 includes a circuit or the like that performs digital image processing on input image data in accordance with an initial setting or a user setting. For example, the image processing section 40 applies gradation correction on the basis of gradation correction data (gradation correction table) under the control of the controller 100. The image processing section 40 also applies, to the image data, various kinds of correction processing such as color correction and shading correction, compression processing, and the like. The processed image data is input to the image forming section 50.

### Image Forming Section

The image forming section 50 includes image forming units 51Y, 51M, 51C, 51K, and an intermediate transfer unit.

### Image Forming Unit

The image forming units 51Y, 51M, 51C, and 51K form images with color toner of a Y component, an M component, a C component, and a K component on the basis of input image data. The image forming units 51Y, 51M, 51C, and 51K have a similar configuration. Therefore, for the purpose of illustration and description, common constituent elements are denoted by the same reference numerals, and when the constituent elements are distinguished from each other, Y, M, C, or K is added to the reference numerals. In FIG. 1, reference numerals are given only to constituent elements of the image forming unit 51Y for the Y component. Reference numerals for the constituent elements of the other image forming units 51M, 51C, and 51K are omitted.

The image forming unit 51 includes an exposure device 511, a developing device 512, a photosensitive drum 513, a charging device 514, and a drum cleaning device 515. Each device constituting the image forming unit 51 has an axis direction in the X direction.

### Exposure Device

The exposure device 511 is composed of, for example, a semiconductor laser. The exposure device 511 scans and exposes the charged photosensitive drum 513 to form a latent image.

### Developing Device

The developing device 512 is a developing device of a two-component developing method. The developing device 512 visualizes an electrostatic latent image by attaching toner of each color component to the surface of the photosensitive drum 513 to form the toner image. The developing roller 512A included in the developing device 512 carries developer while rotating, and supplies the toner contained in the developer to the photosensitive drum 513, thereby forming the toner image on the photosensitive drum 513.

### Photosensitive Drum

The photosensitive drum 513 is, for example, a conductive cylindrical body (aluminum tube) made of aluminum and having a drum diameter of 80 mm. The photosensitive drum 513 includes a negative charge type organic photoreceptor (OPC: organic photo-conductor). In the photosensitive drum 513, three kinds of layers are sequentially laminated on a peripheral surface of the cylindrical body. The three types of layers are an under coat layer (UCL), a charge generation layer (CGL), and a charge transport layer (CTL).

The controller 100 controls a drive current supplied to a drive motor, not illustrated, that rotates the photosensitive drum 513, thereby rotating the photosensitive drum 513 at a constant circumferential velocity.

### Charging Device

The charging device 514 uniformly and negatively charges a surface of the photosensitive drum 513 having photoconductivity.

### Drum Cleaning Device

The drum cleaning device 515 includes a drum cleaning blade, a lubricant application brush 515A, and the like. The drum cleaning device 515 removes transfer residual toner remaining on the surface of the photosensitive drum 513 after a primary transfer. The drum cleaning blade is brought into sliding contact with the surface of the photosensitive drum 513. The lubricant application brush 515A applies a lubricant to the photoreceptor drum 513 for the purpose of enhancing releasability of the toner from the photoreceptor drum 513 and suppressing wear of a photoreceptor film thickness.

### Intermediate Transfer Unit

The intermediate transfer unit 52 includes an intermediate transfer belt 521, a primary transfer roller 522, a plurality of support rollers 523, a secondary transfer roller 524, and a belt cleaning device 526.

### Intermediate Transfer Belt

The intermediate transfer belt 521 is formed with an endless belt and stretched in a loop around the plurality of support rollers 523. At least one of the plurality of support rollers 523 is constituted by a drive roller, and the others are constituted by driven rollers. In particular, a roller 523A disposed on a downstream side of the primary transfer roller 522 for the K component in a belt traveling direction is preferably the drive roller. This allows moving speed of the belt in a primary transfer section to be easily kept constant. The rotation of the drive roller 523A causes the intermediate transfer belt 521 to run in an arrow direction W at a constant speed.

### Primary Transfer Roller

The primary transfer roller 522 is arranged on an inner periphery surface side of the intermediate transfer belt 521 in a manner facing the photosensitive drum 513 of each color component. The primary transfer roller 522 is brought into pressure contact with the photosensitive drum 513 with the intermediate transfer belt 521 interposed therebetween, thereby forming a primary transfer nip for transferring the toner image from the photosensitive drum 513 to the intermediate transfer belt 521.

### Secondary Transfer Roller

The secondary transfer roller 524 is disposed on the outer peripheral surface side of the intermediate transfer belt 521 so as to face a backup roller 523B disposed on the downstream side of the drive roller 523A in the belt traveling direction. The secondary transfer roller 524 is pressed against and brought into contact with the backup roller 523B with the intermediate transfer belt 521 interposed therebetween, thereby forming a secondary transfer nip for transferring the toner image from the intermediate transfer belt 521 to a sheet S.

When the intermediate transfer belt 521 passes through each of the primary transfer nips, the toner image on each of the respective photosensitive drums 513 is sequentially layered and primary transferred onto the intermediate transfer belt 521. Specifically, a primary transfer bias is applied to the primary transfer roller 522 to provide the back surface side of the intermediate transfer belt 521 with charges having a polarity opposite to that of the toner. Through the above-described operation, the toner image is electrostatically transferred onto the intermediate transfer belt 521.

Thereafter, when the sheet S passes through the secondary transfer nip, the toner image on the intermediate transfer belt 521 is secondarily transferred to the sheet S. Specifically, the toner image is electrostatically transferred to the sheet S by applying secondary transfer bias to the secondary transfer roller 524, and applying electric charge having an opposite polarity of the toner to a back surface side of the sheet S. The sheet S on which the toner image has been transferred is conveyed toward the fixing section 70.

### Belt Cleaning Device

The belt cleaning device 526 includes a belt cleaning blade or the like that is in sliding contact with the surface of the intermediate transfer belt 521, and removes transfer residual toner remaining on the surface of the intermediate transfer belt 521 after the secondary transfer. Instead of the secondary transfer roller, a so-called belt-type secondary transfer unit in which a secondary transfer belt is stretched in a loop shape around a plurality of support rollers including the secondary transfer roller may be employed.

### Sheet Conveyance Section

The sheet conveyance section 60 includes a sheet feed section 61, a sheet ejection section 62, a conveyance route section 63, and the like. In the three sheet feed tray units 61a to 61c constituting the sheet feed section 61, the sheets S (standard sheets, special sheets, and the like) identified based on a basis weight, a size, and the like are accommodated for according to each type set in advance. The conveyance route section 63 includes a plurality of conveyance roller pairs such as a registration roller pair 63a.

The sheets S contained in the sheet feed tray units 61a to 61c are fed one by one from the top and are conveyed to the image forming section 50 by the conveyance route section 63. At this time, an inclination of the fed sheet S is corrected and a conveyance timing is adjusted by a registration roller section in which the registration roller pair 63a is arranged. Then, in the image forming section 50, the toner image on the intermediate transfer belt 521 is secondarily transferred to one surface of the sheet S collectively, and a fixing step is performed in the fixing section 70. The sheet S on which the image is formed is discharged to the outside of the apparatus by the sheet ejection section 62 having a sheet ejection roller 62a.

### Fixing Section

The fixing section 70 heats and presses, at a fixing nip, the conveyed sheet S onto which the toner image has been second transferred, to fix the toner image onto the sheet S.

### Storage Section

The storage section 80 includes, for example, a nonvolatile semiconductor memory such as a so-called flash memory and a hard disk drive. The storage section 80 stores various kinds of data including various kinds of setting information regarding the image forming section 50.

### Communication Section

The communication section 90 is constituted by a communication control card such as a local area network (LAN) card. The communication section 90 transmits and receives various data to and from an external apparatus, such as a personal computer, connected to a communication network such as a LAN or a wide are network (WAN).

### Controller

The controller 100 includes a central processing unit (CPU), a read only memory (ROM), a random access memory (RAM), and the like. The CPU reads out a program corresponding to processing contents from the ROM, and deploys it in the RAM. Then, the CPU centrally controls the operation of each unit of the image forming system 1 in cooperation with the deployed program.

The controller 100 serves as a reading controller, a first calculation section, a second calculation section, a third calculation section, a fourth calculation section, a display controller, and a correction section for the purpose of adjustment using an adjustment chart.

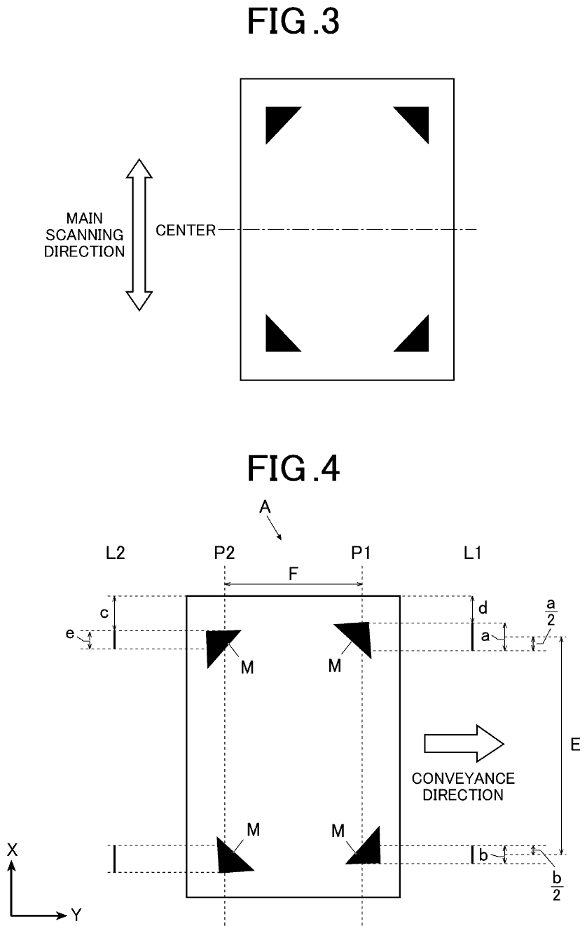

The adjustment chart is formed such that four isosceles right triangle marks are symmetrical with respect to a center in the main scanning direction, as shown in FIG. 3. The formed mark has an oblique side whose width changes in the main scanning direction or the sub-scanning direction, and which has a symmetrical shape with respect to a center line in the main scanning direction, so that an adjustment described later can be performed.

### Reading Controller

As illustrated in FIG. 4, the controller 100 controls the reading scanning section 20 to scan two positions on the mark M formed on the adjustment chart A conveyed in the sub-scanning direction (Y direction) by the reading conveyance section 10 in a line shape in the main scanning direction (X direction) with a width of one pixel in the Y direction. The two positions are a first image cutting position P1 and a second image cutting position P2.

The reading scanning section 20 acquires a cutout image (first image) L1 of one line (reading line) by scanning at a first image cutout position P1. The reading scanning section 20 outputs the acquired image data to the controller 100. Next, the reading scanning section 20 acquires a cutout image (second image) L2 of one line (reading line) by scanning at the second image cutout position P2. The reading scanning section 20 outputs the acquired image data to the controller 100.

In the first image L1, there are two black line images obtained by scanning the mark M. The lengths are denoted by a and b, respectively, and a distance between the centers of the two line images is denoted by E. In addition, a distance from an end portion in the X direction to the line image is denoted by d.

The second image L2 also includes two black line images obtained by scanning the mark M. Among the line images, the distance from the end portion in the X direction to the nearest line image is denoted by c. The length of the line image closest to the end portion in the X direction is denoted by e.

The distance between the first image cutout position P1 and the second image cutout position P2 is denoted by F.

### First Calculation Section

The controller 100 calculates the inclination in the main scanning direction based on the image data acquired by the reading scanning section 20. Specifically, an angle α is calculated by the following Expression (1) based on a, b, and E in FIG. 4.

$$Angle ( α ) = ( a - b ) / E * 100 ( \% ) \qquad Expression ( 1 )$$

### Second Calculation Section

The controller 100 calculates the inclination in the sub-scanning direction based on the image data acquired by the reading scanning section 20. Specifically, the angle β is calculated by the following Expression (2) based on c, d, and F in FIG. 4.

$$Angle ( β ) = ( c - d ) / F * 100 ( \% ) \qquad Expression ( 2 )$$

### Third Calculation Section

The controller 100 calculates an angular deviation amount (angle γ) between the sheet conveyance direction of the reading conveyance section 10 and the main scanning direction of the reading scanning section 20 from the inclination (angle α) in the main scanning direction and the inclination (angle β) in the sub-scanning direction. Specifically, based on the angle α and the angle β, the angle γ is calculated by the following Expression (3).

$$Angle ( γ ) = Angle ( α ) - Angle ( β ) ( \% ) \qquad Expression ( 3 )$$

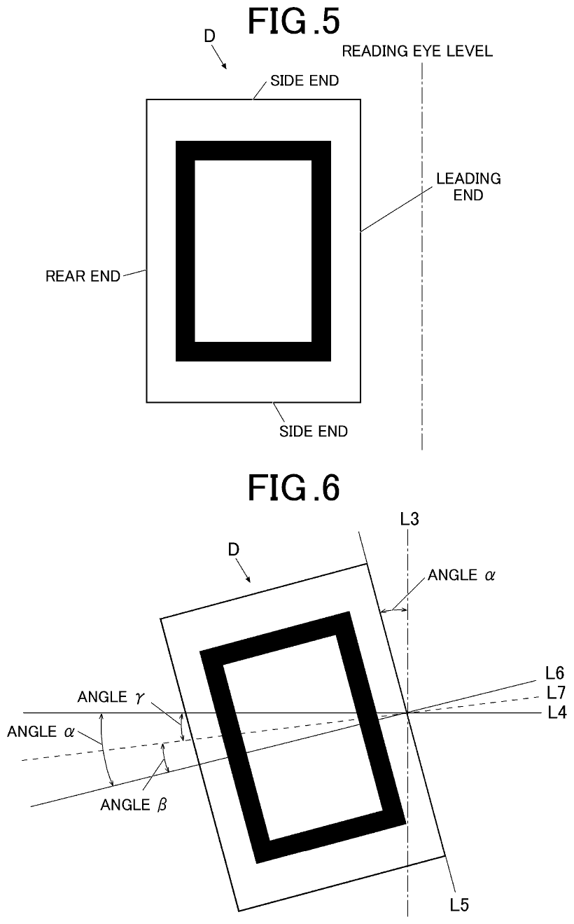

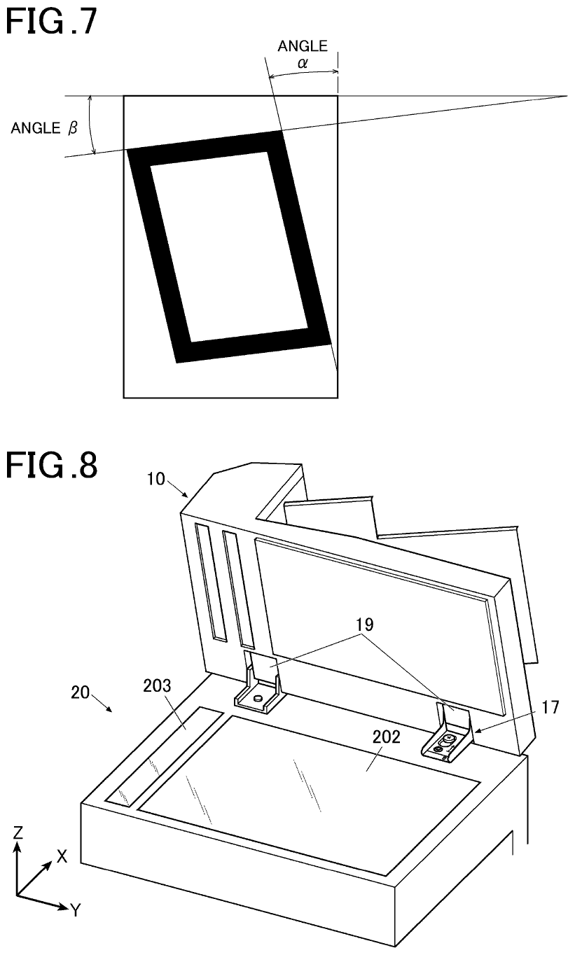

How the angle α, the angle β, and the angle γ appear in the process of reading the document D and obtaining the image data will be described using the process of reading the document as shown in FIG. 5 in the inclined state as shown in FIG. 6 and obtaining the image data as shown in FIG. 7. FIG. 5 shows a document on which a mark perpendicular or parallel to the leading end, side end, and rear end of the sheet are formed. FIG. 6 illustrates a case where the document conveyed in a conveyance direction L7 is read at a reading eye level L3. An extended line L5 of the leading end of the document is inclined by the angle α with respect to the reading eye level L3. Corresponding to this inclination, a perpendicular line L6 with respect to an extended line of the leading end of the document is inclined by the angle α with respect to a perpendicular line L4 of the reading eye level. The perpendicular line L6 with respect to the extended line of the leading end of the document is inclined by the angle β with respect to the conveyance direction L7. Here, it is understood that the angle γ representing the angular deviation amount is obtained by subtracting the angle β from the angle α as illustrated in the left part of FIG. 6. FIG. 7 illustrates the image data obtained when the document is read in the inclined state as illustrated in FIG. 6. When the document is read in the inclined state as shown in FIG. 6, the image data in which the mark formed on the document is inclined by the angle α in the main scanning direction and by the angle β in the sub-scanning direction is obtained. In FIG. 6, when the document is read after the adjustment corresponding to the angle γ is performed, it is found that the inclination of the mark in the obtained image data is reduced.

### Fourth Calculation Section

The controller 100 calculates, from the angular deviation amount (angle γ), an adjustment amount for making the angular deviation amount zero. The controller 100 performs the calculation based on the angular deviation amount (the angle γ) and a preliminarily measured relationship of an adjustment scale movement amount in an angle adjustment mechanism 17 (described later) of the reading conveyance section 10 and the reading scanning section 20 with respect to the angular deviation amount (the angle γ). The controller 100 displays the adjustment amount on the display part 32.

More specifically, the controller 100 calculates the adjustment amount from data in which the relationship of the adjustment scale movement amount in the angle adjustment mechanism 17 (described later) of the reading conveyance section 10 and the reading scanning section 20 with respect to the angular deviation amount (angle γ) is tabulated. Further, the controller 100 may create an approximate expression from the above relationship and calculate the adjustment amount from the created approximate expression.

### Angle Adjustment Mechanism

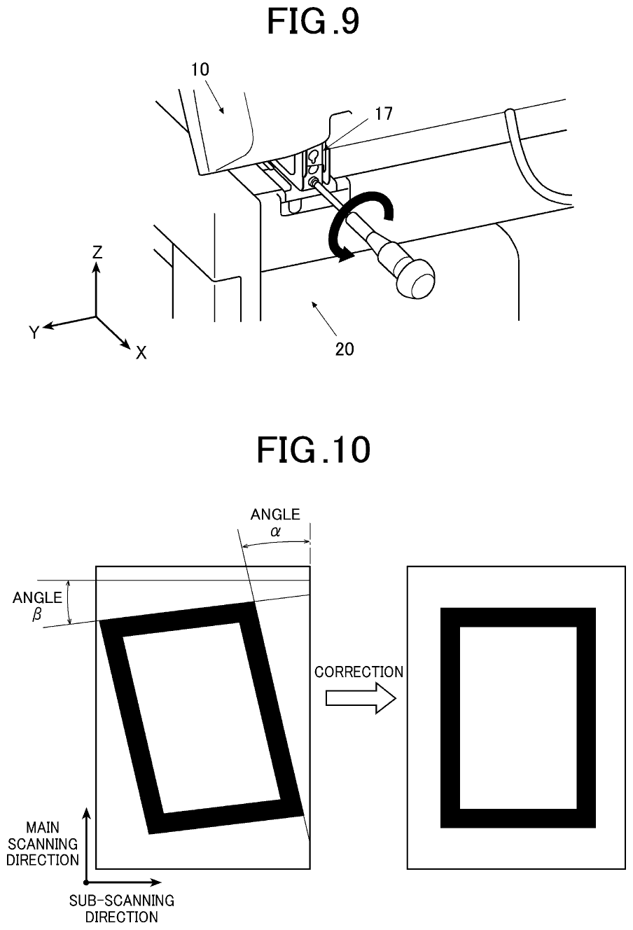

As shown in FIG. 8, the angle adjustment mechanism 17 is provided at one of two hinge portions for connecting the reading conveyance section 10 and the reading scanning section 20. The user can adjust the angle between the reading conveyance section 10 and the reading scanning section 20 by adjusting a degree of tightening of a screw illustrated in FIG. 9 of the angle adjustment mechanism 17. The scale provided in the angle adjustment mechanism 17 corresponds to the adjustment amount, and the user can perform adjustment for setting the angular deviation amount (angle γ) to zero.

### Correction Section

As illustrated in FIG. 10, the controller 100 corrects the document image data on the basis of the inclination (angle α) in the main scanning direction and the inclination (angle β) in the sub-scanning direction. Specifically, the document image data obtained by reading the adjustment chart conveyed by the reading conveyance section 10 using the reading scanning section 20 is corrected by the angle α in the main scanning direction and by the angle β in the sub-scanning direction.

### Display Controller

The controller 100 outputs the angular deviation amount (angle γ) and the adjustment amount to the display part 32.

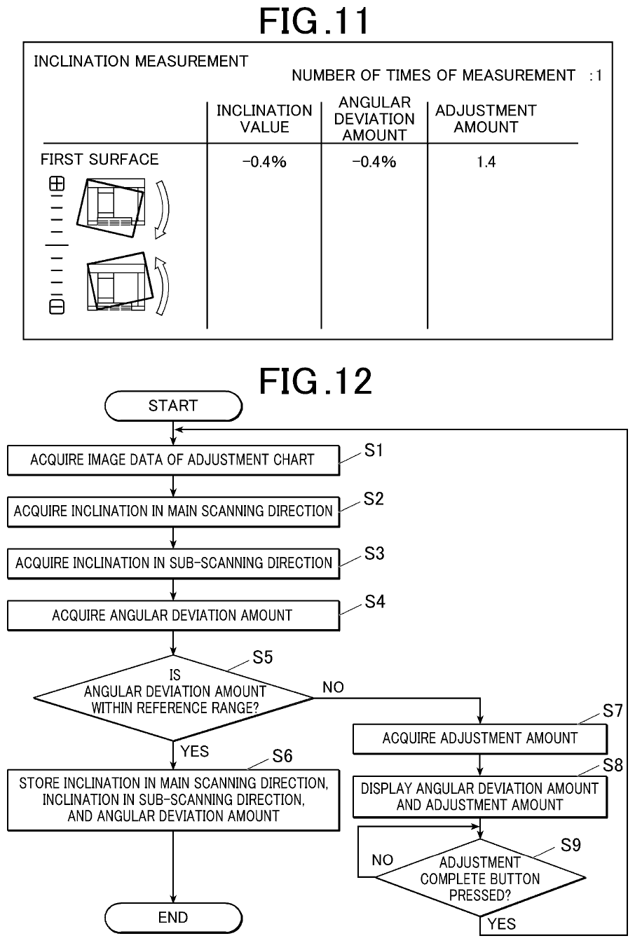

An example of output to the display part 32 is illustrated in FIG. 11.

FIG. 12 is a flowchart illustrating angle adjustment processing using the adjustment chart. This processing is implemented by software processing in cooperation between the controller CPU and the program stored in the ROM.

The controller 100 causes the reading conveyance section 10 and the reading scanning section 20 to read the adjustment chart. The controller 100 as a reading controller controls the reading conveyance section 10 and the reading scanning section 20 so as to read the mark formed on the adjustment chart at two positions (the first image cutout position P1 and the second image cutout position P2). At this time, the controller 100 controls the reading conveyance section 10 and the reading scanning section 20 so as to read, at the two positions, reading lines that are one or more pixels in the sub-scanning direction and are pixels corresponding to the width of the adjustment chart in the main scanning direction at intervals in the sub-scanning direction.

The controller 100 acquires the image data of the two positions of the adjustment chart A in the above process (step S1).

The controller 100, as the first calculation section, calculates the inclination in the main scanning direction from the image data and acquires the inclination (angle α) in the main scanning direction (step S2).

The controller 100, as the second calculation section, calculates the inclination in the sub-scanning direction from the image data and acquires the inclination (angle β) in the sub-scanning direction (step S3).

The controller 100, as the third calculation section, calculates the angular deviation amount from the inclination in the main scanning direction and the inclination in the sub-scanning direction, and acquires the angular deviation amount (angle γ) (step S4).

The controller 100 determines whether the acquired angular deviation amount is within a reference range (step S5).

When the angular deviation amount is within the reference range (step S5; YES), the controller 100 stores the inclination in the main scanning direction, the inclination in the sub-scanning direction, and the angular deviation amount in the storage section 80 (step S6), and ends the process.

If the angular deviation amount is not within the reference range (step S5; NO), the controller 100, as the fourth calculation section, calculates, from the angular deviation amount, the adjustment amount for making the angular deviation amount zero, and acquires the adjustment amount (step S7). The controller 100 performs the calculation based on the angular deviation amount and the preliminarily measured adjustment scale movement amount of the angle adjustment mechanism 17 with respect to the angular deviation amount. The controller 100, as a display controller, controls the display part 32 to display the angular deviation amount and the adjustment amount (step S8). The user adjusts the angle adjustment mechanism 17 on the basis of the adjustment amount and presses an adjustment completion button of the operation part. The controller 100 determines whether the adjustment has been completed through the operation part 31 (step S9). When the adjustment is completed (step S9; YES), the controller 100 proceeds to step S1.

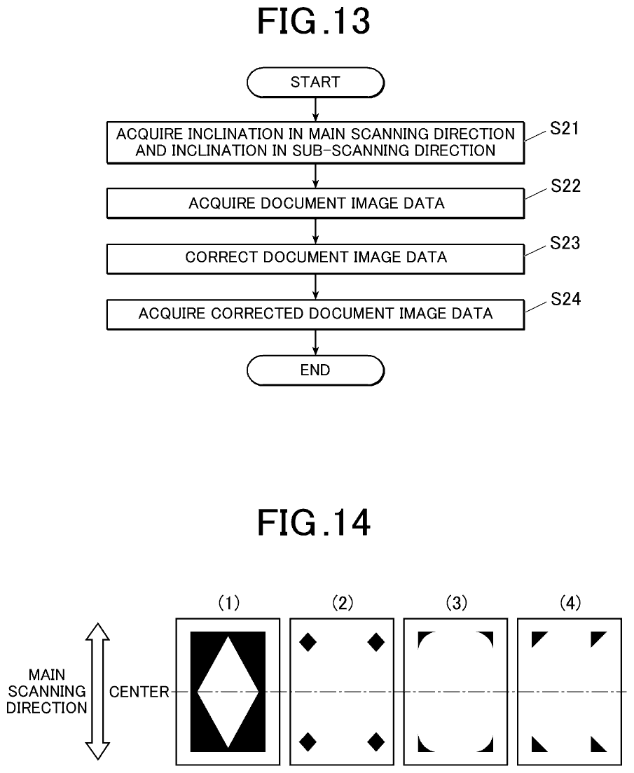

FIG. 13 is a flowchart illustrating correction processing by a correction section. This processing is implemented by software processing in cooperation with the CPU of the controller 100 and the program stored in the ROM.

The controller 100 acquires the inclination in the main scanning direction and the inclination in the sub-scanning direction from the storage section 80 (step S21).

The controller 100 causes the reading conveyance section 10 and the reading scanning section 20 to read the document and acquires the document image data (step S22).

The controller 100 corrects the document image data based on the inclination in the main scanning direction and the inclination in the sub-scanning direction and acquires the corrected document image data (step S23). To be specific, the controller makes a correction such that the main scanning direction of the document image data is rotated by the inclination (amount of inclination) of the main scanning direction and the sub-scanning direction of the document image data is rotated by the inclination (amount of inclination) of the sub-scanning direction (step S24).

The controller 100 ends the processing for correcting the document image data.

As described above, according to the present embodiment, the inclination in the main scanning direction and the inclination in the sub-scanning direction can be obtained by reading, by the image reading device 500, the adjustment chart on which the mark having a plurality of oblique sides that change in width in the main scanning direction or the sub-scanning direction and are symmetrically shaped with respect to the center line in the main scanning direction as shown in FIG. 3 is formed. Furthermore, the angular deviation amount between the sheet conveyance direction of the reading conveyance section 10 and the main scanning direction of the reading scanning section 20 and a corresponding adjustment amount of the angle adjustment mechanism 17 of the reading conveyance section 10 and the reading scanning section 20 can be obtained from the inclination in the main scanning direction and the inclination in the sub-scanning direction. Using this adjustment amount, the angle adjustment mechanism 17 of the reading conveyance section 10 and the reading scanning section 20 can be adjusted so that the angle between the conveyance direction in which the document is conveyed by the reading conveyance section 10 and the main scanning direction of the reading scanning section 20 has the smaller angular deviation amount. Further, by obtaining the inclination in the main scanning direction and the inclination in the sub-scanning direction, it is possible to obtain the image data obtained by correcting the inclination in the main scanning direction and the inclination in the sub-scanning direction of the read document image data.

### Modification Example

FIG. 14 is an example of the adjustment chart that can be used as a modification example. In the adjustment chart of (1), one mark having a shape in which a rhombic hole is opened in a rectangle is formed so as to be line symmetrical with respect to the center line in the main scanning direction and the center line in the sub-scanning direction. The width of the mark is changed in each scanning direction by the rhombic hole, and four oblique sides having a symmetrical shape with respect to the main scanning direction are formed, so that the same adjustment as in the present embodiment can be performed. In the adjustment chart of (2), four congruent rhombic marks are formed so as to be line symmetrical with respect to the center line in the main scanning direction and the center line in the sub-scanning direction. Since the four rhombic marks are formed in line symmetry with respect to the center line in the main scanning direction, the width of the mark changes in each scanning direction, and since 16 oblique sides which are symmetrically shaped with respect to the main scanning direction are formed by the sides of each rhombus, the same adjustment as in the present embodiment can be performed. In the adjustment chart of (3), four congruent marks in the shape of a square from which quadrants each having one side of the square as a radius are removed are formed so as to be line symmetrical with respect to the center line in the main scanning direction and the center line in the sub-scanning direction. The width of the mark is changed in each scanning direction by the arc-shaped oblique sides, and four arc-shaped oblique sides which are symmetrically shaped with respect to the main scanning direction are formed, so that the same adjustment as in the present embodiment can be performed. In the adjustment chart of (4), four congruent isosceles right triangle marks are formed so as to be line symmetric with respect to the center line in the main scanning direction and so that the directions of two marks on the same side with respect to the center line in the main scanning direction are the same. Due to the oblique sides of the isosceles right triangle, the width of the mark changes in each scanning direction, and four oblique sides that are symmetrical with respect to the main scanning direction are formed, so that the same adjustment as in the present embodiment can be performed.

Note that the term “calculation” in the above-described embodiment has an ordinary meaning, and in addition, means to extract a necessary value from the data including a correspondence relationship between two or more parameters stored in advance in the storage section. For example, the “calculation” by the fourth calculation section has an ordinary meaning, and in addition, means to extract the necessary value from the data including the correspondence relationship between a specific angle and an adjustment amount stored in advance in the storage section.

Note that the calculation of the inclination in the sub-scanning direction by the second calculation section in the above-described embodiment may be performed by the following Expression (4) based on a, e, and F in FIG. 4.

$$Angle ( β ) = ( a - e ) / F * 100 ( \% ) \qquad Expression ( 4 )$$

Note that the term “oblique side” in the adjustment chart has an ordinary meaning and in addition, means a line that is neither parallel nor perpendicular to the vertical and horizontal sides of the sheet, among the sides of the mark formed in the adjustment chart. The oblique side includes not only a straight line but also a curved line. For example, since the oblique side of the adjustment chart of (3) of FIG. 14 is an arc, it is a curve.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. An image reading device comprising:
a reading conveyor;
a reading scanner configured to read an image of a sheet conveyed by the reading conveyor during conveyance; and
a hardware processor,
wherein,
the hardware processor performs control such that, from an adjustment chart in which one mark or a plurality of marks are formed, the one mark having a plurality of oblique sides whose widths change in a main scanning direction or a sub-scanning direction and which are symmetrically shaped with respect to a center line in the main scanning direction and the plurality of marks include the oblique side, the one mark or the plurality of marks are read at two or more locations in a reading line that is one or more pixels in the sub-scanning direction and that includes pixels corresponding to a width of the adjustment chart in the main scanning direction at intervals in the sub-scanning direction,
the hardware processor calculates an inclination in the main scanning direction from a difference in a mark width in one read line that has been read, and
the hardware processor calculates the inclination in the sub-scanning direction from the difference in a position or a width of the mark in the two reading lines which are read with the interval in the sub-scanning direction.

2. The image reading device according to claim 1, wherein the hardware processor calculates an angular deviation amount between the sheet conveyance direction of the reading conveyor and the main scanning direction of the reading scanner from the calculated inclination in the main scanning direction and the calculated inclination in the sub-scanning direction.

3. The image reading device according to claim 2, wherein the hardware processor displays the calculated angular deviation amount on a display.

4. The image reading device according to claim 3, wherein,
the reading conveyor includes an angle adjustment mechanism that adjusts a relative angle with respect to a main scanning direction of the reading scanner,
the hardware processor calculates an adjustment amount that sets the angular deviation amount to zero from the calculated angular deviation amount, and
the hardware processor displays the calculated adjustment amount that sets the angular deviation amount to zero on the display.

5. The image reading device according to claim 1, wherein the hardware processor corrects, using the calculated inclination in the main scanning direction and the calculated inclination in the sub-scanning direction, inclinations in the main scanning direction and the sub-scanning direction of image data obtained by reading, by the reading scanner, the sheet conveyed by the reading conveyor.

6. A non-transitory computer-readable storage medium storing a program that causes a computer of an image reading device that reads an image of a sheet conveyed by a reading conveyor using a reading scanner during conveyance to,
perform control such that, from an adjustment chart in which one mark or a plurality of marks are formed, the mark having a plurality of oblique sides whose widths change in a main scanning direction or a sub-scanning direction and which are symmetrically shaped with respect to a center line in the main scanning direction, the one mark or the plurality of marks are read at two or more locations in a reading line that is one or more pixels in the sub-scanning direction and that includes pixels corresponding to a width of the adjustment chart in the main scanning direction at intervals in the sub-scanning direction,
calculate an inclination in the main scanning direction from a difference in a mark width in one read line that has been read, and
calculate the inclination in the sub-scanning direction from the difference in a position or a width of the mark in the two reading lines which are read with the interval in the sub-scanning direction.

7. An image forming system comprising:
the image reading device according to claim 1; and
an image former that forms an image on a sheet using image data obtained by the image reading device.
